(19) United States
(12) Patent Application Publication
(10) Pub. No.: US 2022/0297773 A1
(43) Pub. Date: Sep. 22, 2022

(54) Portable Dock Trailer

(71) Applicant: JET Polymer Recycling, Inc., Fort Payne, AL (US)

(72) Inventors: Edward A. Traylor, Dutton, AL (US); Scotty Prestwood, Henagar, AL (US)

(21) Appl. No.: 17/611,146

(22) PCT Filed: May 14, 2020
(86) PCT No.: PCT/US20/32804

§ 371 Date: Nov. 13, 2021

Related U.S. Application Data
(60) Provisional application No. 62/847,686, filed on May 14, 2019.

(51) Int. Cl. B62D 53/06; B60P 1/43; B62D 21/20; B65G 69/30; B65G 67/02

(52) U.S. Cl. CPC B62D 53/062; B60P 1/433; B62D 21/20; B65G 69/30; B65G 67/02

(57) ABSTRACT

A portable dock trailer is provided herein. In various embodiments, the portable dock trailer includes a frame, a ramp, a loading deck, and a mechanism for raising and lowering the ramp. The portable dock trailer permits the loading and unloading of cargo when a traditional loading dock is not available. Embodiments of the portable dock trailer are configured to assume a towing position to be used during transport and a loading position to be used at a loading site.

### CROSS REFERENCE TO RELATED APPLICATIONS

This application claims the benefit of priority under 35 U.S.C. § 119(e) to U.S. Provisional Application No. 62/847,686, filed May 14, 2018, which is incorporated herein by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not as admissions of prior art.

### Field of the Invention

The present inventive concept relates to the field of portable dock trailers. More particularly, the inventive concept relates to an improved system for loading and unloading cargo when a traditional loading dock is not available.

### Technology in the Field of the Invention

Loading docks are useful structures for loading and unloading cargo into a trailer or other receptacle before or after transport. However, loading and unloading cargo can be problematic when no loading dock is available or all of the loading docks are occupied at a given loading site. Further, when a truck full of cargo breaks down on route to a particular destination, moving cargo from the broken-down vehicle to a functioning truck can be a cumbersome and expensive process.

Thus, the absence of a loading dock can cause unexpected delays in the movement of goods or other cargo, which can result in delivery interruptions, scheduling problems, wasted fuel costs, costly overtime pay to drivers or other employees, and other inefficiencies that can substantially reduce profit margins for the cargo transportation industry.

As such a portable loading dock is required that can be easily moved from place to place to assist with the loading and unloading of cargo when a traditional loading dock is not available.

### BRIEF SUMMARY OF THE INVENTION

A portable dock trailer is disclosed herein. The portable dock trailer can comprise a frame, a ramp, a loading deck, or a combination thereof. In one embodiment, the dock trailer further comprises a mechanism for raising and lowering the ramp. In embodiments, the mechanism for raising and lowering the ramp comprise a fluid-powered mechanism. The ramp can be raised and lowered via pneumatics or hydraulics. In alternate embodiments, the ramp is configured to be manually raised and lowered to a desired height through the physical actions of at least one user. In still other configurations, the ramp is locked in a single position.

In one embodiment, the frame comprises at least two wheels. The portable dock trailer can be configured to be pulled as a trailer by a towing vehicle.

The ramp of the portable dock trailer can be configured to be reversibly secured into a locked position. In one embodiment, the means for reversibly securing the ramp in a locked position comprises a locking pin and a pin receiver, a system of notches and locking bars, a combination thereof, or any alternate means known to one of skill in the relevant art.

In embodiments comprising a loading deck, the height of the loading deck can be adjustable or the loading deck can be in a fixed position relative to the frame. The portable dock trailer can include a mechanism for raising and lowering the loading deck. The mechanism for raising and lowering the loading deck can include a fluid-powered mechanism. In embodiments, the loading deck is raised and lowered via pneumatics or hydraulics. The mechanism for raising and lowering the loading deck can include a manual mechanism configured to be raised and lowered by physically lifting the loading deck through the actions of at least one user.

In certain embodiments, the portable dock trailer comprises a means for reversibly securing the loading deck in a locked position. The means for reversibly securing the loading deck in a locked position can be a locking pin and a pin receiver, a system of notches and locking bars, a combination thereof, or any alternate means known to one of skill in the relevant art.

In one embodiment of the portable dock trailer, the ramp is secured to the frame via at least one pivot member, wherein the pivot member is configured to permit the ramp to be raised and lowered with relation to the frame.

The ramp can further include at least one bridge member. In embodiments, the ramp bridge member is disposed at a back end of the ramp and configured to prevent a gap from forming between the ramp and ground surface when the ramp assumes a loading position.

The loading deck can also comprise a first loading deck bridge member that is disposed at a back end of the loading deck and configured to prevent a gap from forming between the loading deck and the ramp when the ramp assumes a loading position. The loading deck can comprise a second loading deck bridge member disposed at a front end of the loading deck that is configured to prevent a gap from forming between the loading deck and a loading surface.

The loading deck can be configured to attach to a towing vehicle via any means commonly known in the relevant rat. In embodiments, the loading deck is attached to a towing vehicle via a class 1-5 receiver hitch, a bumper-mounted hitch, a 5th wheel hitch, a gooseneck hitch, any other suitable hitch mechanism, or combinations thereof.

The portable dock trailer can further comprise at least one foot support. The at least one foot support can be retractable and configured to support the portable dock trailer when the dock trailer assumes a loading position. The portable dock trailer can be provided with at least two foot supports. In embodiments with at least two foot supports, each foot support can be configured to be raised and lowered independently.

A method of loading and unloading cargo when no loading dock is available is also disclosed herein. The method provides for hauling a portable dock trailer to a loading site and placing the portable dock trailer in a loading position. Cargo can then be loaded or unloaded into a receiving unit.

A system for unloading and loading cargo is also disclosed herein. In various exemplary embodiments, the system comprises a portable dock trailer. The portable dock trailer can be configured to assume a towing position, a loading position, or a combination thereof.

The portable dock trailer used in the system can comprise a frame, a ramp, a loading deck, a mechanism for raising and lowering the ramp, or a combination thereof. The portable dock trailer can include a mechanism for raising and lowering the loading deck. In one embodiment, a front end of the ramp can be lowered relative to the loading deck when in the towing position. In contrast, the front end of the ramp can be disposed adjacent to the loading deck when in a loading position.

### BRIEF DESCRIPTION OF THE DRAWINGS

So that the manner in which the present inventive concepts can be better understood, certain illustrations, photographs, charts and/or flow charts are appended hereto. It is to be noted, however, that the drawings illustrate only selected embodiments of the inventive concepts and are therefore not to be considered limiting of scope, for the inventive concepts may admit to other equally effective embodiments and applications.

FIG. 1A represents a top perspective view of a portable dock trailer in accordance with an embodiment of the present inventive concept. The dock trailer is shown in loading position with the ramp raised.

FIG. 1B shows a top view of the portable dock trailer of FIG. 1A.

FIG. 2A represents a top perspective view of a portable dock trailer in accordance with an embodiment of the present inventive concept. The dock trailer is shown in a towing position with ramp lowered and the loading deck raised.

FIG. 2B shows a top view of the FIG. 2A dock trailer.

FIG. 3A provides a side view of the dock trailer of FIG. 1A, in the loading position.

FIG. 3B shows a side view of the dock trailer of FIG. 2A, in the towing position.

FIG. 4A shows the portable dock trailer of FIG. 3A in a loading position and situated upon a trailer to permit loading or unloading of the trailer.

FIG. 4B shows the portable dock trailer of FIG. 3B in a towing position and attached to the bed of a pick-up truck to permit transport of the dock trailer.

FIG. 5A represents a top perspective view of a ramp of the portable dock trailer in accordance with an embodiment of the present inventive concept.

FIG. 5B provides a top view of the ramp of FIG. 5A.

FIG. 5C provides a side view of the ramp of FIG. 5A.

FIG. 5D shows a detailed view of the front end of the ramp of FIG. 5A. A channel for receiving a locking pin is visible.

FIG. 6A represents a top perspective view of a loading deck of the portable dock trailer in accordance with an embodiment of the present inventive concept.

FIG. 6B provides a top view of the FIG. 6A loading deck.

FIG. 6C shows a side view of the loading deck of FIG. 6A.

FIG. 7A represents a top perspective, detailed view of a hitch attachment that is separated from the loading deck of FIG. 6A.

FIG. 7B shows a back view of the hitch attachment of FIG. 7A.

FIG. 7C shows a side view of the hitch attachment of FIG. 7A.

FIG. 7D shows a top view of the hitch attachment of FIG. 7A.

FIG. 8A represents a top perspective view of a frame of the portable dock trailer in accordance with an embodiment of the present inventive concept. A hydraulic box can be seen mounted to the front end of the frame.

FIG. 8B provides a top view of the frame of FIG. 8A.

FIG. 8C shows a side view of the frame of FIG. 8A.

FIG. 9 represent a detailed schematic view of an exemplary hydraulic system that can be employed in accordance with one embodiment of the present inventive concept.

FIG. 10 provides a detailed side schematic view of the junction between the ramp and the loading deck in one embodiment of a portable dock trailer in a loading position. The ramp is shown with two hydraulic cylinders extended to place the ramp in a raised position above the frame.

FIG. 11 provides a schematic view of a hydraulic cylinder extended to support the loading deck in a towing position under one embodiment of the present inventive concept. The view is taken from underneath the loading deck, facing the front of the ramp and the frame.

FIG. 12A is a schematic view showing how the hydraulic cylinder of the FIG. 11 embodiment attaches to the frame.

FIG. 12B provides a photographic view of how the hydraulic cylinder of FIG. 11 embodiment attaches to the underside of the loading deck, under one embodiment.

FIG. 13 shows a schematic, side perspective view of two hydraulic cylinders extended to support the front of the ramp under one embodiment.

FIG. 14A is a schematic view showing the pivot member upon which the ramp connects to the frame.

FIG. 14B is a schematic view of the pivot member of FIG. 14A extending through a structural beam of the ramp.

FIG. 15 provides a schematic view of one side of the portable dock trailer, looking from the front to the back of the dock trailer under one embodiment. The ramp is shown in a slightly inclined position relative to the frame.

FIG. 16 is a schematic view of the dock trailer showing the underside of the ramp and the top side of the frame.

FIG. 17A provides a schematic view of an alternate embodiment wherein the loading deck is in a fixed, elevated position as compared to the frame. The view is taken from underneath the loading deck, facing the frame and ramp.

FIG. 17B is a detailed schematic view of the FIG. 17A embodiment. As can be seen, the attachment arm of the loading deck is directly attached to the frame such that the loading deck remains in a fixed, elevated position for towing or loading.

### DETAILED DESCRIPTION OF CERTAIN EMBODIMENTS

Detailed descriptions of one or more preferred embodiments are provided herein. It is to be understood, however, that the present inventive concept may be embodied in various forms. Therefore, specific details disclosed herein are not to be interpreted as limiting, but rather as a basis for the claims and as a representative basis for teaching one skilled in the art to employ the present inventive concept in any appropriate manner.

### Definitions

The singular forms “a,” “an,” and “the” include plural reference unless the context clearly dictates otherwise. The use of the word “a” or “an” when used in conjunction with the term “comprising” in the claims and/or the specification may mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly “an example,” “exemplary” and the like are understood to be non-limiting.

The term “substantially” allows for deviations from the descriptor that do not negatively impact the intended purpose. Descriptive terms are understood to be modified by the term “substantially” even if the word “substantially” is not explicitly recited. Therefore, for example, the phrase “wherein the lever extends vertically” means “wherein the lever extends substantially vertically” so long as a precise vertical arrangement is not necessary for the lever to perform its function.

The terms “comprising” and “including” and “having” and “involving” (and similarly “comprises,” “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c. Wherever the terms “a” or “an” are used, “one or more” is understood, unless such interpretation is nonsensical in context.

As used herein the term “about” is used to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

As used herein, the term “loading position” refers to particular orientation of the portable dock trailer. As such, the term “loading position” is not to be interpreted as limiting the function of the dock trailer when so positioned. For instance, when in the loading position, the portable dock trailer is suitable for assistance with the loading of cargo into a trailer or other receptacle, but it is also suitable for the unloading of cargo from a trailer or other receptacle. In embodiments, the portable dock trailer can be configured to be towed while in the loading position. In addition, the loading position can be an appropriate position for storing the portable dock trailer when not in active use.

Likewise, the term “towing position” refers to a particular orientation of the portable dock trailer, and should not be interpreted as limiting the function of the dock trailer with so positioned. For instance, the dock trailer can be stored as well as towed while in the “towing position.”

### DESCRIPTION OF SELECTED SPECIFIC EMBODIMENTS

A portable dock trailer and systems and methods of use thereof are disclosed herein. In various exemplary embodiments, the portable dock trailer comprises a ramp, a loading deck, a frame, or a combination thereof. The ramp, the loading deck, or both can be adjustable to permit the dock trailer to assume a loading position or a towing position.

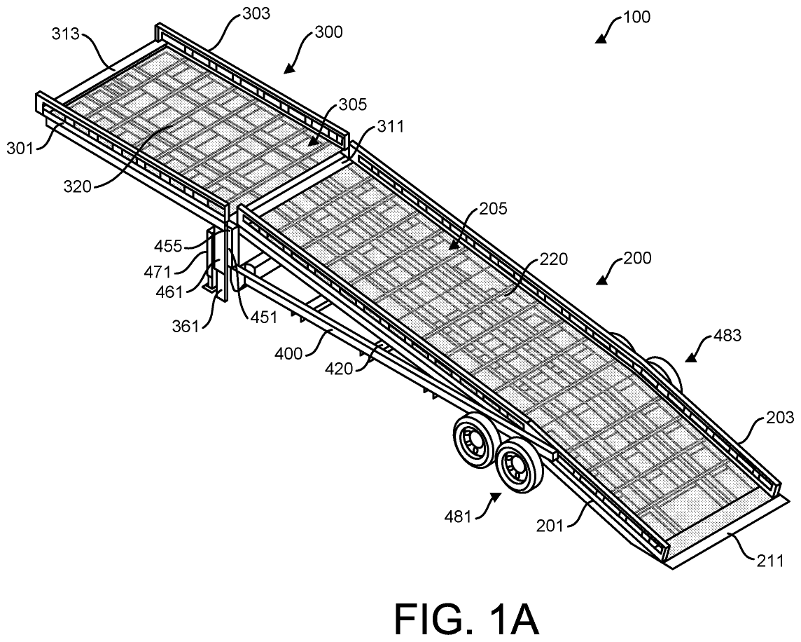

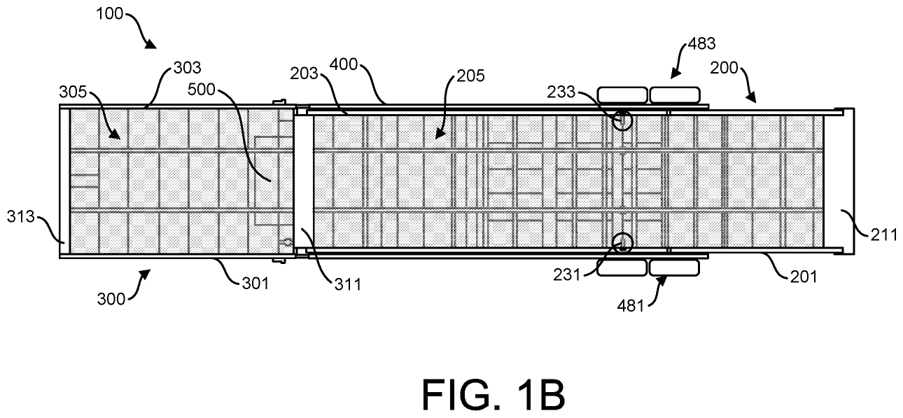

FIGS. 1A and 1B provide a perspective and top view, respectively, of an illustrative portable dock trailer 100 in a loading position in accordance with one embodiment of the present inventive concept. As illustrated, the embodiment comprises a ramp 200, a loading deck 300, and a frame 400. The ramp 200 and loading deck 300 can each have a floor 205, 305, which is shown in phantom to reveal a series of support beams 220, 320 that traverse both longitudinally and transversely across the ramp 200 and loading deck 300. Certain embodiments can comprise only transverse beams, while alternate embodiments can comprise only longitudinal beams.

The floor 205, 305 of the ramp 200, loading deck 300, or both can be comprised of any material suitable for supporting the weight of a wheeled vehicle. In embodiments, the floor 205, 305 is comprised of metal, cellulose, rubber, plastic, or any other suitable material or combinations of materials. The floor 205, 305 can be comprised of a metal expanded sheet. In certain embodiments, the floor 205, 305 is comprised of stainless steel. The floor can be comprised of carbon. In embodiments, the floor 205, 305 is made of solid wood or composite wood.

The ramp 200 is shown attached to the frame 400 at a pivot point 231, 233. When so attached, the pivot point 231, 233 serves as a hinge to permit the front portion of the ramp to be raised while the back portion of the ramp is lowered and vice versa. In the FIG. 1 embodiment, the ramp 200 is shown with its front end raised such that the front-most end of the ramp is adjacent to the rear-most end of the loading deck 300. This configuration of the portable dock trailer is referred to as the “loading position.” When so situated, the ramp 200 and loading deck 300 are joined to form a continuous surface upon which a vehicle may traverse with relative ease.

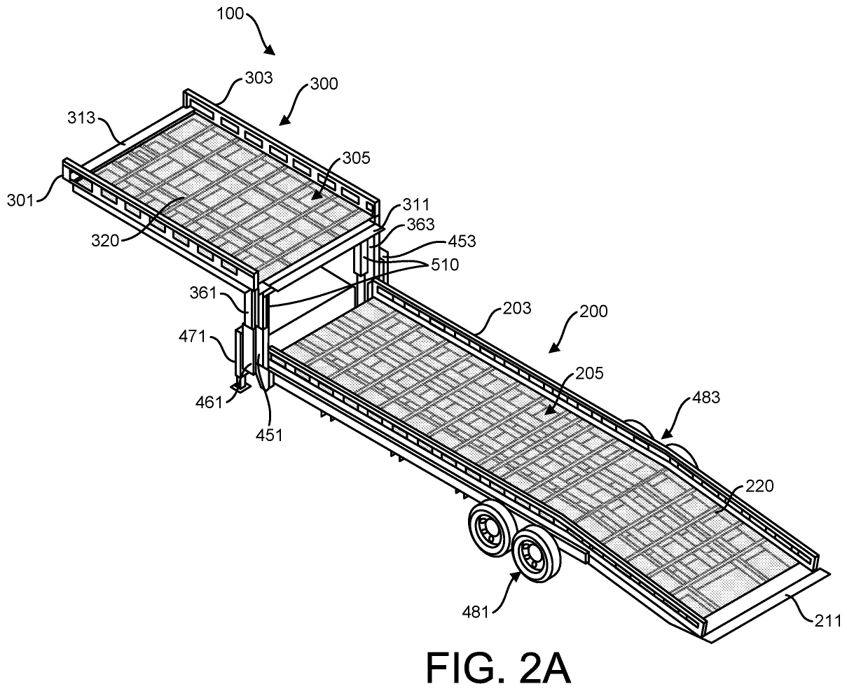

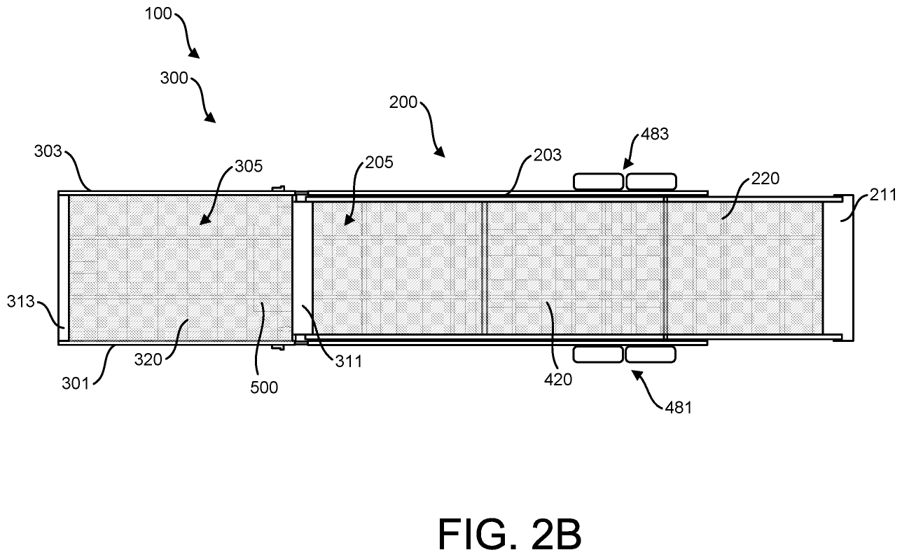

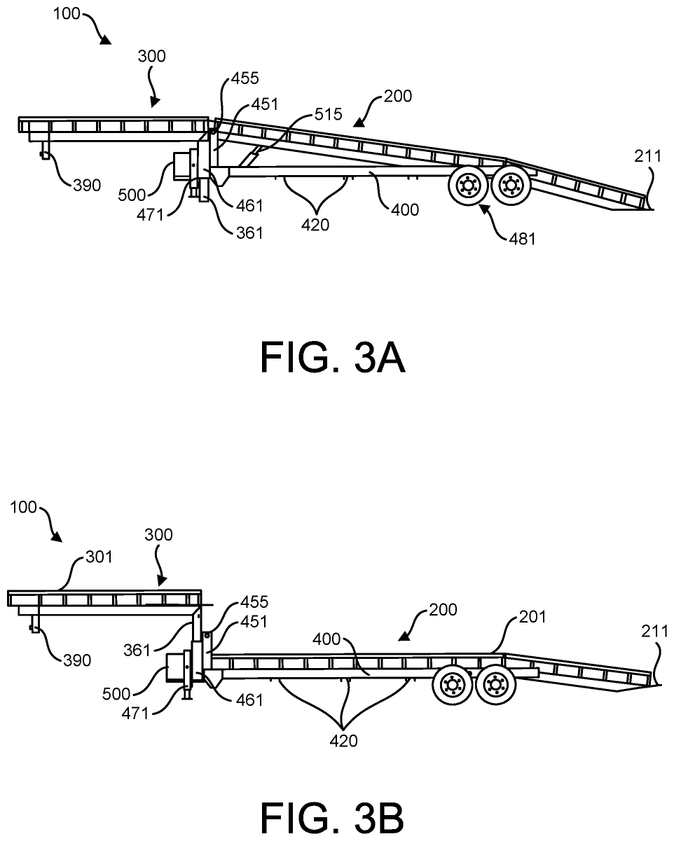

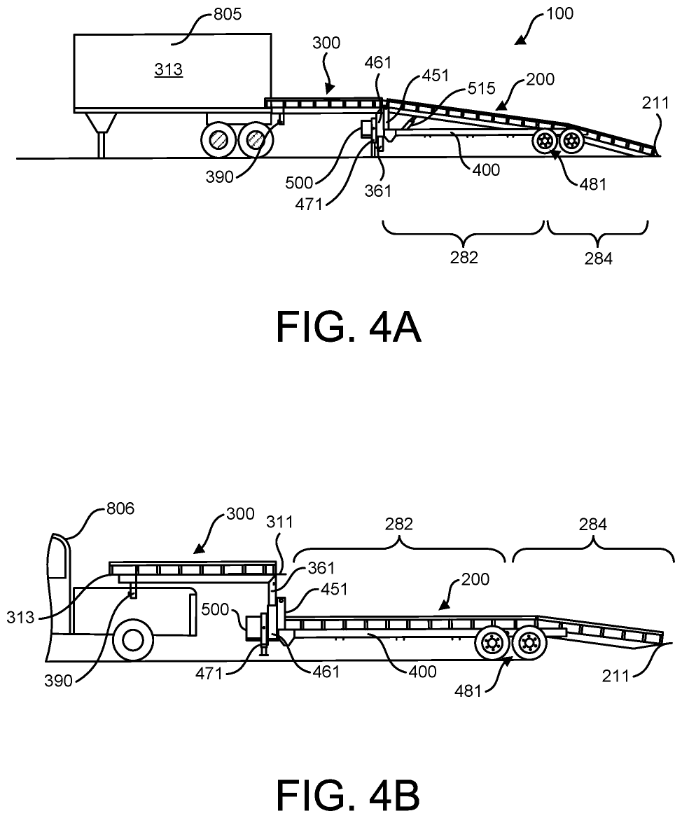

To prevent the formation of gaps between the adjoining regions of the ramp 200 and the loading deck 300, a bridge 311 can be included that extends beyond the rear-most portion of the loading deck (shown more clearly in FIGS. 2A and 3B). The loading deck 300 can also include a bridge 313 configured to prevent the formation of a gap between the loading deck 300 and a trailer or other receptacle into or from which cargo is loaded or unloaded, respectively (seen more clearly in FIG. 4A). In addition, a bridge 211 can be disposed upon the rear-most portion of the ramp 200 to minimize the formation of a gap between the ground and the ramp, thereby facilitating the passage of a wheeled vehicle onto and off of the ramp with minimal disturbance of the vehicle or the cargo being transported.

In embodiments, the ramp 200 and loading deck 300 can further include side railing 201, 203, 301, 303.

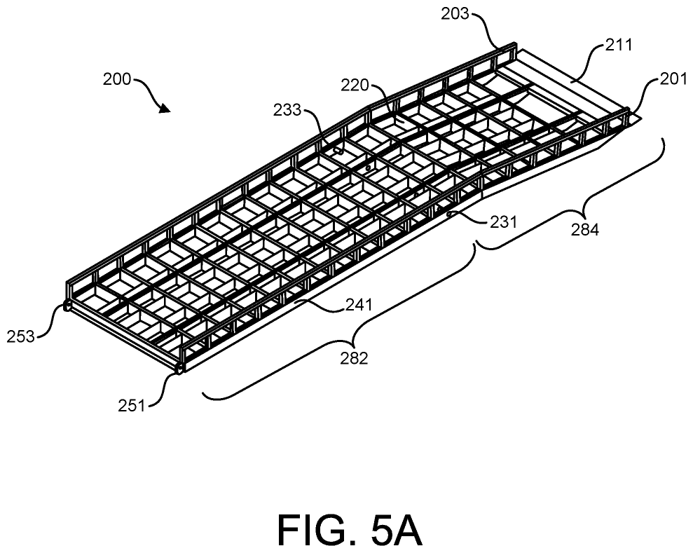

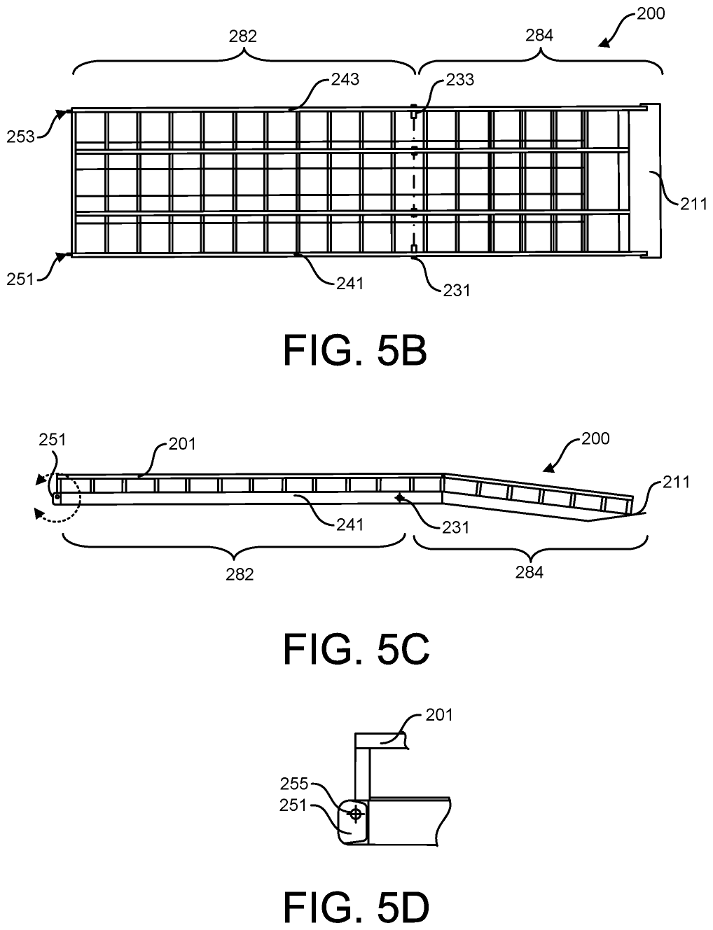

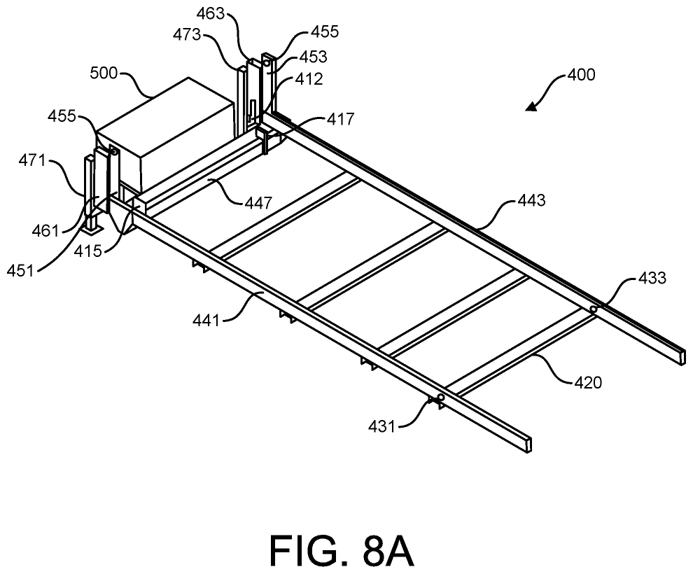

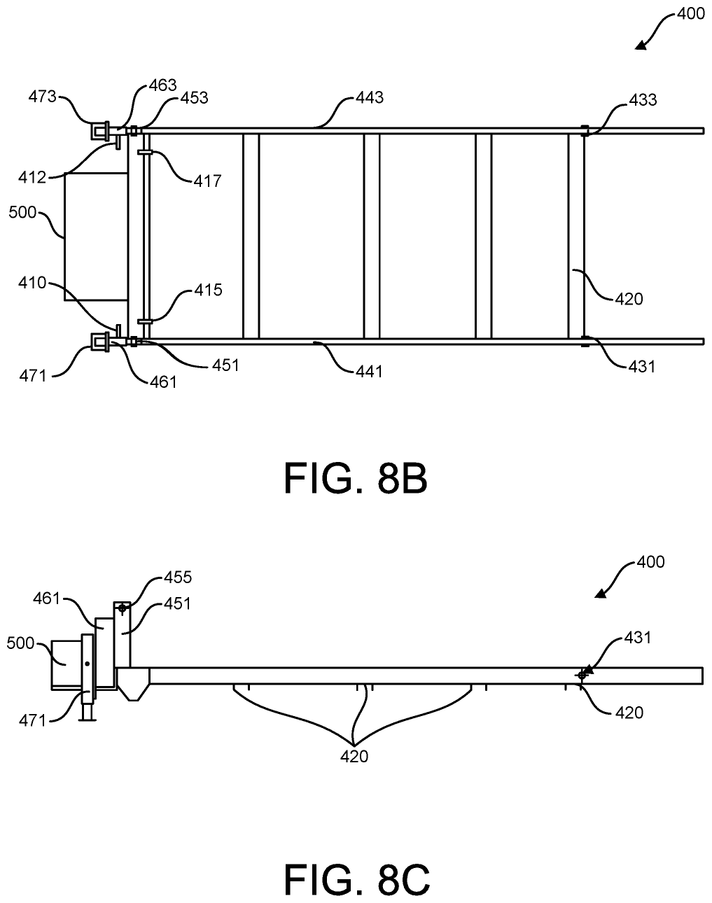

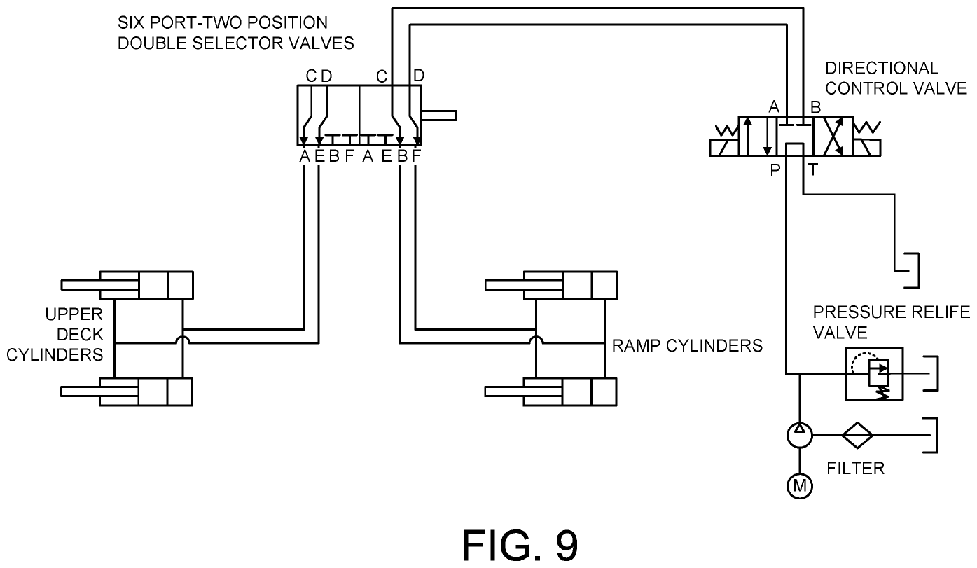

The frame 400 is shown beneath the ramp 200, and a series of support beams 420 can be partially seen traversing the width of the frame (transverse beams) 400. In alternate embodiments, the frame comprises longitudinal beams. The frame can comprise both longitudinal beams and transverse beams. The frame 400 can further comprise at least two ramp supports 451 (and 453 of FIG. 8) that extend upward from the frame 400. In embodiments, the ramp support 451, comprises at least one hole, gap, or channel that serves as a locking pin receiver 455 through which a locking pin (not shown) can extend into a hole, gap, or channel (more clearly seen at 255 of FIG. 5) the front-most portion of the ramp (see 251 and 253 of FIG. 5).

The frame 400 can also comprise at least two attachment arm receivers 461 (and 463 of FIG. 8), each of which are configured to receive an attachment arm 361 of the loading deck 300.

The frame 400 can also comprise at least one foot support 471, which can be lowered to support the portable dock trailer 100 on the ground. In embodiments, the foot support 471 is comprised of a jack system that raises and lowers the dock trailer 100 to permit coupling and uncoupling of the portable dock trailer to and from the towing vehicle. In embodiments the frame includes at least two foot supports (seen more clearly at 471 and 473 of FIG. 8). In embodiments with at least two foot supports, each foot support can be independently raised and lowered to permit leveling of the portable dock trailer when the dock rests on unlevel ground. The foot support can be configured to be manually raised and lowered by a user or automatically raised and lowered through hydraulic, pneumatic, or any suitable alternative means.

The frame can further include at least one axel and a set of associated wheels 481, 483. As shown in the various embodiments of the figures, the frame 400 can include at least two axels and two sets of wheels.

A control box 500 can be seen disposed upon the front-most portion of the frame. This control box 500 can house the electronic and mechanical components to permit automatic lifting and lowering of the loading deck, ramp, foot supports, or a combination thereof (discussed in more detail below).

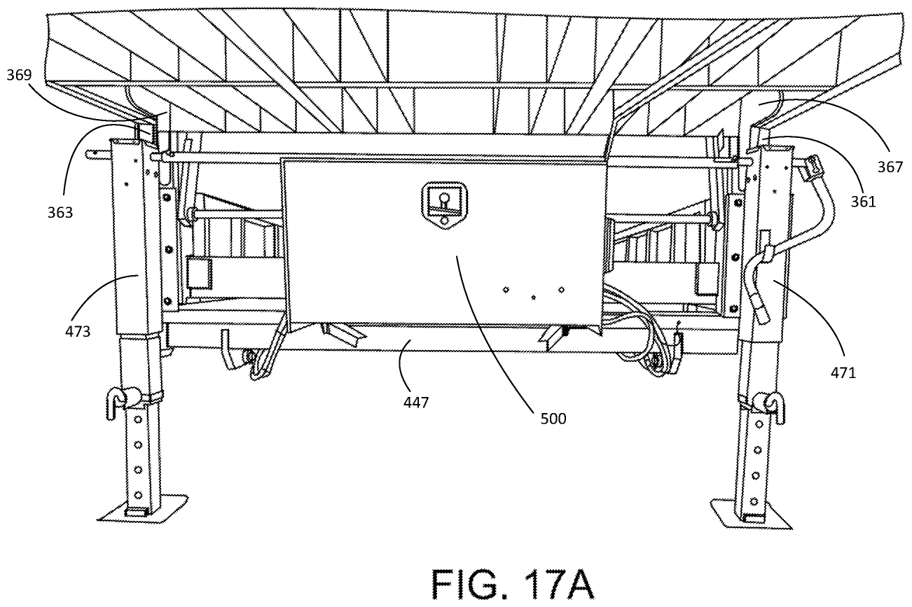

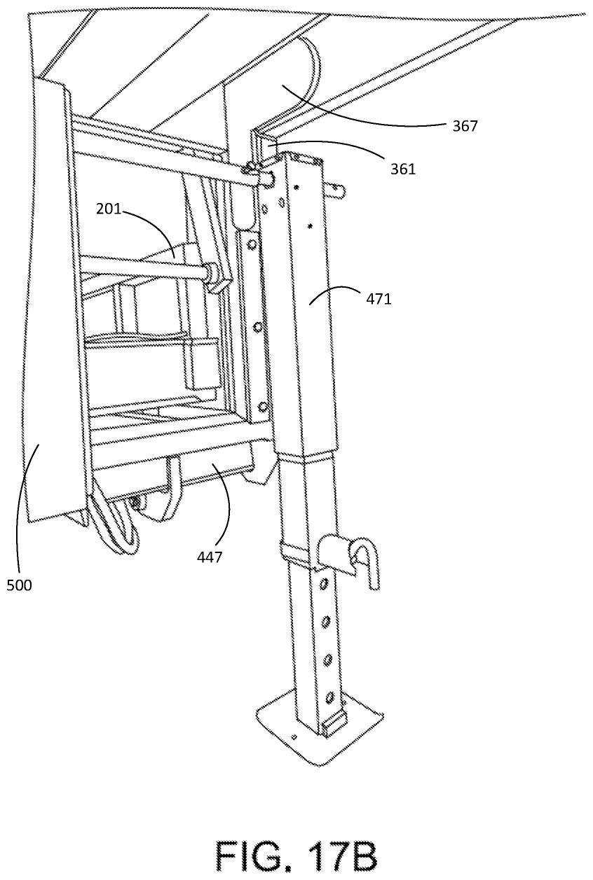

FIG. 2A shows a top perspective view of the portable dock trailer 100, and FIG. 2B shows a top view of the dock trailer 100 in the towing position. As can be seen, in the towing position, the front end of the ramp 200 is lowered and the back end of the ramp is raised such that neither the ramp 200 nor the ramp bridge 211 contacts the ground. In this particular representation, the loading deck 300 is raised to permit engagement of a hitch mechanism disposed upon a towing vehicle (more clearly shown with reference to FIG. 4B). A substantial portion of the attachment arm 361, 363 can be seen extending from the attachment arm receivers 461, 463 of the frame 400. In this particular embodiment, two hydraulic cylinders 510 are seen disposed beneath the back portion of the loading deck 300 and are shown as being substantially parallel to the attachment arms 361, 363 of the loading deck 300. The hydraulic cylinders can be used to automatically raise and lower the loading deck. In some embodiments, the loading deck 300 is raised and lowered by an alternate means. The loading deck 300 can be raised and lowered via pneumatics or electromechanical systems. Electromechanical systems can convert rotational force into linear motion, such as through the use of an electric motor to drive a ball nut along a ball screw. In some embodiments, the loading deck 300 is raised and lowered manually by a user to a desired location. In alternate embodiments, the loading deck is not adjustable and remains fixed in a towing or loading position (see, for example, FIGS. 17A and 17B).

FIG. 3A provides a side view of one portable dock trailer embodiment in the loading position. In this view, the ramp support 451, attachment arm receivers 461, and the foot support 471 of the frame 400 are clearly visible. In addition, the control box 500 is shown attached to the front-most portion of the frame 400.

A hydraulic cylinder 515 is shown extending at an angle from the frame 400 to the ramp 200. The hydraulic cylinder can extend from the frame 400 at any angle. In embodiments, the hydraulic cylinder 515 extends from the ramp at an angle between about 10° and about 170°, inclusive. The cylinder 515 can extend from the ramp 200 at an angle between about 30° and 150°, inclusive. In embodiments, the hydraulic cylinder 515 extends from the ramp 200 at angle from about 45° to about 100°. The hydraulic cylinder 515 can extend an angle of about 90°. In one embodiment, the hydraulic cylinder 515 extends at an angle from about 30° to about 50°. The hydraulic cylinder can extend from the ramp 200 at an angle from about 40° to about 45°. In one embodiment, the hydraulic cylinder extends from the ramp 200 at an angle of about 45°.

In operation of certain embodiments, the hydraulic cylinder provides the lift mechanism for raising and lowering the ramp 200 to a desired height. In some embodiments, the ramp 200 is raised and lowered by an alternate means. The ramp 200 can be raised and lowered via pneumatics or electromechanical systems. In one embodiment, electromechanical systems can convert rotational force into linear motion, such as through the use of an electric motor to drive a ball nut along a ball screw. In some embodiments, the ramp 200 is raised and lowered manually by a user to a desired location. The lift mechanism can comprise any suitable means for lifting and lowering the ramp 200.

In certain embodiments, the lift mechanism comprises a gravity tilt mechanism, such as a hydraulic cushion cylinder, which permits lowering and raising of the ramp 200 at a controlled rate. In such embodiments, when weight is diverted to the back section 284 of the trailer, the piston of the cylinder is extended, which permits lowering of the back section 284 of the ramp and raising of the front section 282 of the ramp 200 such that the portable dock trailer 100 assume the loading position. To return the ramp to a stowed position in such embodiments, weight can be applied to the front section 282 of the ramp 200, which forces retraction of the hydraulic piston to permit the front section 282 of the ramp to be lowered and the back section 284 to be raised at a controlled rate. In embodiments with a gravity tilt hydraulic lift mechanism, a diversion valve can be installed to close the hydraulic system once the piston on the cylinder is extended, which, along with a locking pin or other locking mechanism in certain embodiments, can serve to maintain the ramp in an elevated position during a loading or unloading event.

In alternate embodiments, the ramp 200 is not adjustable and remains fixed in a loading position. In embodiments wherein the ramp is in a fixed loading position the back end of the ramp can be shorter than in adjustable embodiments to prevent the ramp from contacting the ground during transport. As such, the ramp 200 can comprise a bridge or other mechanism that is configured to extend the length of the ramp to permit the formation of a continuous surface for a wheeled vehicle to easily access the portable dock trailer with minimal disturbance. In embodiments, the bridging mechanism is configured be folded, extended, or otherwise added to the ramp such that the portable dock trailer contacts the ground surface during a loading or unloading event. In certain embodiments wherein the ramp is in a fixed loading position, the bridge is detachable such that the bridge can be attached during loading and unloading of cargo and removed during transport of the portable dock trailer.

Also in the FIG. 3A embodiment, the attachment arm 361 of the loading deck 300 can be seen extending down through the attachment arm receiver 461, indicating that, when in the loading position, the loading deck 300 can be in a lowered position as compared to the towing position (compare to the attachment arm 361 of FIG. 3B).

FIG. 3B shows a side view of an exemplary portable dock trailer in a towing position. As can be seen, in this particular embodiment, the front section 282 of the ramp 200 is in a lowered position and substantially parallel with the frame 400. In embodiments, the ramp 200 is configured to rest directly upon the cross beams 420 of the frame 400 when in the towing position. The hydraulic cylinder (seen at 515 of FIG. 3A) of the ramp 400 is now in a retracted position under the ramp 400 and is no longer visible.

Also in the FIG. 3B embodiment, the loading deck 300 is shown in a raised position as evidenced by a substantial portion of the attachment arm 361 extending out of the top of the attachment arm receiver 461. When so disposed the loading deck 300 is positioned to be attached to a hitch mechanism of a towing vehicle (more clearly seen in FIG. 4B). In the pictured embodiment, the loading deck 300 comprises a hitch attachment 390 that is configured to permit the portable dock trailer to be reversibly fastened to a towing vehicle via the towing vehicle's hitch mechanism.

FIG. 4A provides an illustration showing a side view of the portable dock trailer 100 under one embodiment, in a loading position and situated behind a semi-trailer 805. The front bridge 313 of the loading deck 300 is shown extending as a ledge into the rear-most portion of the trailer 805. A foot support 471 is shown extended such that the foot plate is flush with the ground, thereby providing support for the portable dock trailer 100. In this particular embodiment, the wheels 481 of the portable dock trailer are elevated above the ground as a prophylactic measure to prevent the dock trailer from moving or shifting during the loading or unloading process. In alternate embodiments, the wheels 481 remain in contact with the ground when the dock trailer 100 is disposed in the loading position.

The hydraulic cylinder 515 between the ramp 200 and the frame 400 is shown extended such that the front section 282 of the ramp 200 is raised. When so disposed, the front-most portion of the ramp 200 is in contact with the loading deck 300. Further, the back section 284 of the ramp in in a lowered position such that the bridge 211 of the ramp 200 is substantially flush with the ground, which permits access to the dock trailer 100 by a wheeled vehicle. The wheeled vehicle can comprise a fork lift, a dolly, hand truck, a pallet jack, or any other vehicle suitable for lifting or moving cargo.

In FIG. 4B, the portable dock trailer 100 is shown in a towing position and attached to a hitch mechanism of a towing vehicle 806. The foot support 471 is retracted such that the foot plate is raised above the ground, thereby providing sufficient clearance for transport of the portable dock trailer. The wheels 481 are also shown in contact with the ground. In the pictured orientation, the front section 282 of the ramp 200 is lowered, and the rear section 284 of the ramp 200 is raised, which prevents the ramp 200 from contacting or dragging along the ground during transport of the portable dock trailer 100.

In the FIG. 4B embodiment, the loading deck 300 comprises a hitch attachment 390 that is configured to permit the portable dock trailer to be reversibly fastened to a towing vehicle via the towing vehicle's hitch mechanism. The loading deck 300 is shown in an elevated position with the attachment arm 361 extending out of the top of the attachment arm receiver 461 of the frame 400. Such a configuration permits the loading deck 300 to be attached to the hitch mechanism within the bed of a towing vehicle 806. This configuration provides for a tight turning radius as there is substantial clearance for the towing vehicle 806 to make sharp turns while minimizing the risk of the truck bed colliding with the portable dock trailer 100 during transport or parking. This orientation further permits easier maneuvering of the portable dock trailer 100 and is particularly useful in satiations where there is limited space for placing the portable dock trailer 100 in the desired location. In alternate embodiments, the portable dock trailer 100 can be towed at a lower height, such as at the bumper-level of the towing vehicle 806.

In this FIG. 4B embodiment, the towing vehicle 806 is a pick-up truck. In alternative embodiments, the towing vehicle comprises a semi-trailer. The towing vehicle can be a car, SUV, tractor, ATV, or any vehicle suitable for transporting a trailer. Although the portable dock trailer 100 is shown attached to a hitch mechanism within the bed of a towing vehicle 806, the dock trailer 100 can be reversibly fastened to a towing vehicle via any mechanism known within the relevant art. In embodiments, loading deck 300 is configured to attach to a towing vehicle via a class 1 receiver hitch, a class 2 receiver hitch, a class 3, receiver hitch, a class 4 receiver hitch, a class 5 receiver hitch, a bumper-mounted hitch, a 5th-wheel hitch, a gooseneck hitch, any other suitable hitch mechanism, or combinations thereof.

FIGS. 5A, 5B, and 5C provide a top perspective, top, and side view, respectively, of the ramp 200 of FIG. 1. In the FIG. 5 embodiment, the floor has been removed to more clearly show the support beams 220 of the ramp 200. Side rails 201, 203 can be seen extending across the length of the ramp 200. A channel that extends through receivers 231, 233 is shown, which can align with a complementary channel (seen at 431, 433 of FIG. 8) to form a pivot point through which a pivot member can be inserted to connect the ramp 200 to the frame (seen at 400 of FIG. 8). As discussed in more detail with reference to FIG. 20, in one embodiment, a cross bar slides through the complementary channels of the ramp 231, 233 and the frame 431, 433 to serve as a hinge or fulcrum that permits the ramp 200 to be raised and lowered.

As most clearly seen in FIG. 5C, the ramp can comprise a front section 282 and an end section 284. As shown, the end section 284 of the ramp 200 can extend downward at an angle from the front section 282 of the ramp. In embodiments, the angle from which the end section 284 extends from the front section 282 ranges from about 1° to about 45°. The angle of the end section 284 can extend from about 1° to about 30°. The end section 284 can extend from the front section 282 at an angle between about 1° to about 15°, inclusive. In embodiments, the end section 284 extends from the front section 282 at an angle of about 1°, 2°, 3°, 4°, 5°, 6°, 7°, 8°, 9°, or 10°. In certain embodiments, the angle at which the end section 284 extends from the front section 282 is adjustable. In alternate embodiments, the end section 284 is substantially coplanar with the front section 282.

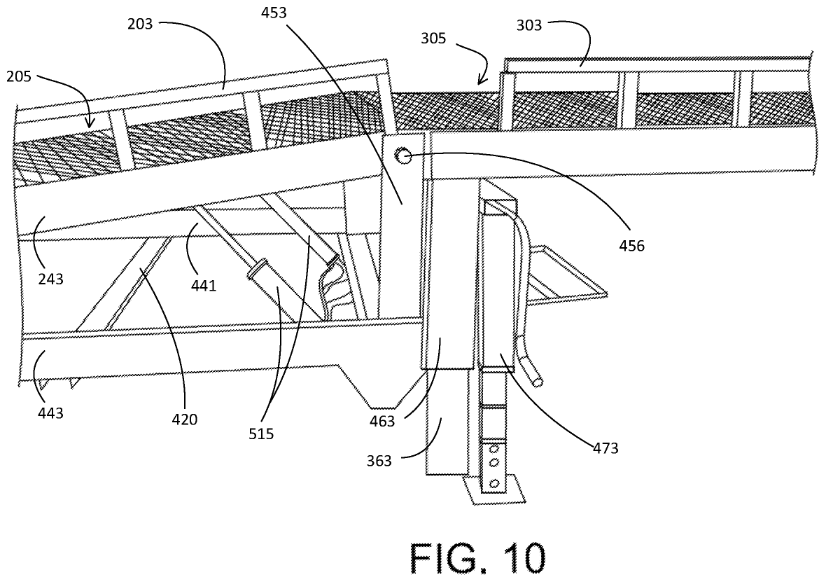

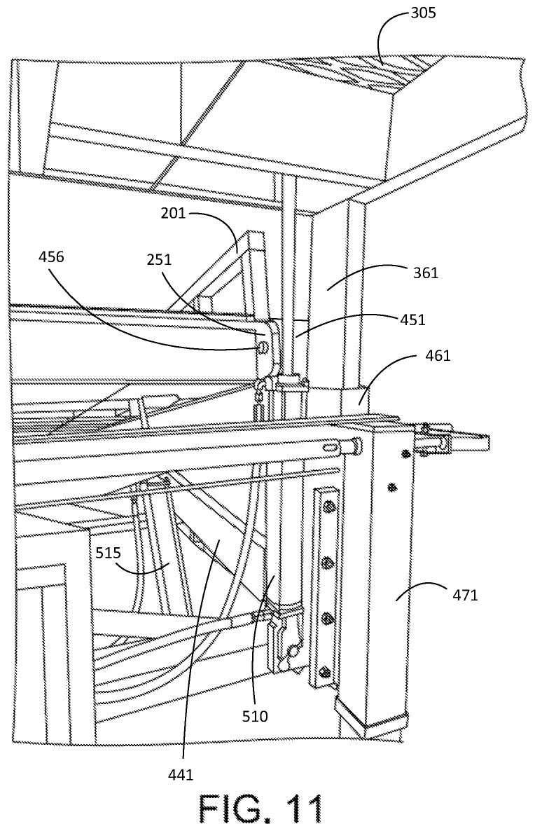

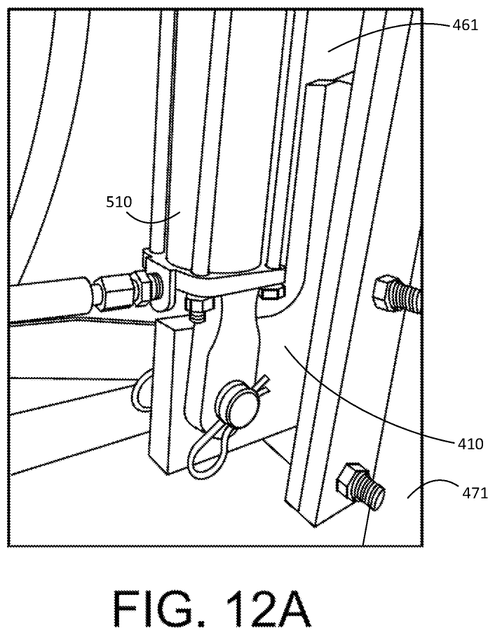

The front-most portion of each side of the ramp 200 of the FIG. 5 embodiment comprises a lock pin gusset 251, 253. As shown in the detailed image of FIG. 5D, the lock pin gusset comprises a lock pin channel 255, through which a locking pin (seen at 456 of FIGS. 10 and 11) can be inserted to secure the ramp 200 in a desired position. As discussed briefly above with reference to FIG. 1, in operation of embodiments with a locking pin mechanism, the user raises the front section 282 of the ramp 200 to a desired height and aligns the lock pin channel 255 of the ramp 200 with a complementary locking pin receiver 455 disposed on the ramp supports 451, 453 of the frame 400. When so arranged, a locking pin (not shown) can be inserted through both the locking channel 255 and the locking pin receiver 455 to lock the ramp into the appropriate position.

The ramp 200 can include at least one lift mechanism attachment point that permit coupling of the lift mechanism to the ramp 200. Certain embodiments comprise two lift mechanism attachment points. Embodiments configured to permit manual positioning of the ramp 200 can be provided without a lift mechanism attachment point.

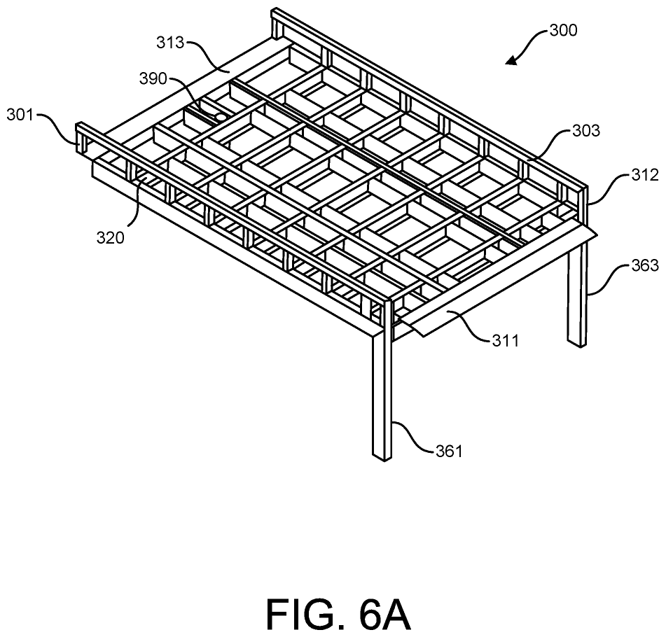

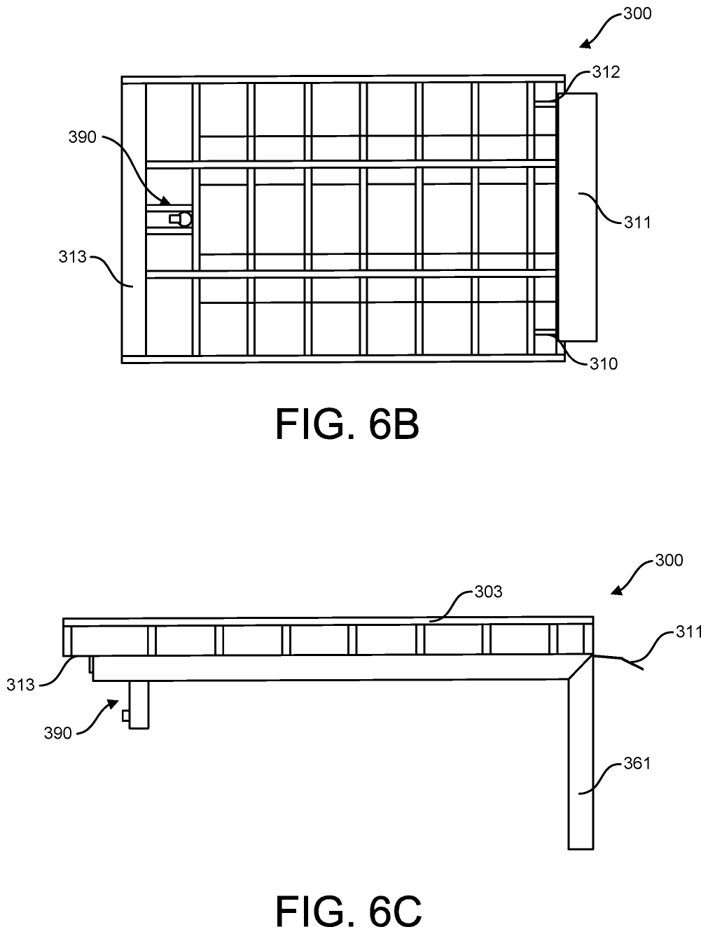

FIGS. 6A, 6B, and 6C provide a top perspective, top, and side view, respectively, of the loading deck 300 of FIG. 1. In the FIG. 6 embodiment, the floor has been removed to more clearly show the support beams 320 of the loading deck 300. Side rails 301, 303 are shown extending the length of the loading deck 300 and onto the font bridge 313. The rear bridge 311 is shown extending out from the back of the loading deck 300.

Two attachment arms 361, 363 are seen extending down from the loading deck 300. As discussed generally above with reference to FIG. 1, the attachment arms 361, 363 extend through the attachment arm receivers 461, 463 of the frame 400. In operation, the attachment arm receivers 461, 463 secure the attachment arms 361, 363 of the loading deck 300 to the frame 400 of the portable dock trailer 100. The attachment arm receivers 461, 463 serve as channels to permit vertical movement of the attachment arms 361, 363 therethrough—thereby permitting the loading deck 300 to be raised and lowered to a desired height by the users.

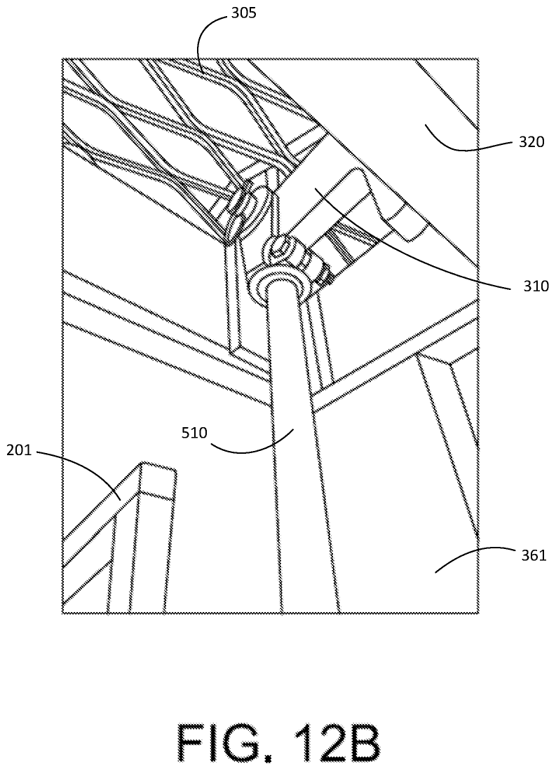

In embodiments, the loading deck 300 includes at least one lift mechanism attachment point (see elements 310, 312 of FIGS. 6B and 310 of FIG. 12B) that permit coupling of the lift mechanism to the loading deck 300. Certain embodiments comprise two lift mechanism attachment points 310, 312. Embodiments configured to permit manual positioning of the loading deck 300 can be provided without a lift mechanism attachment point.

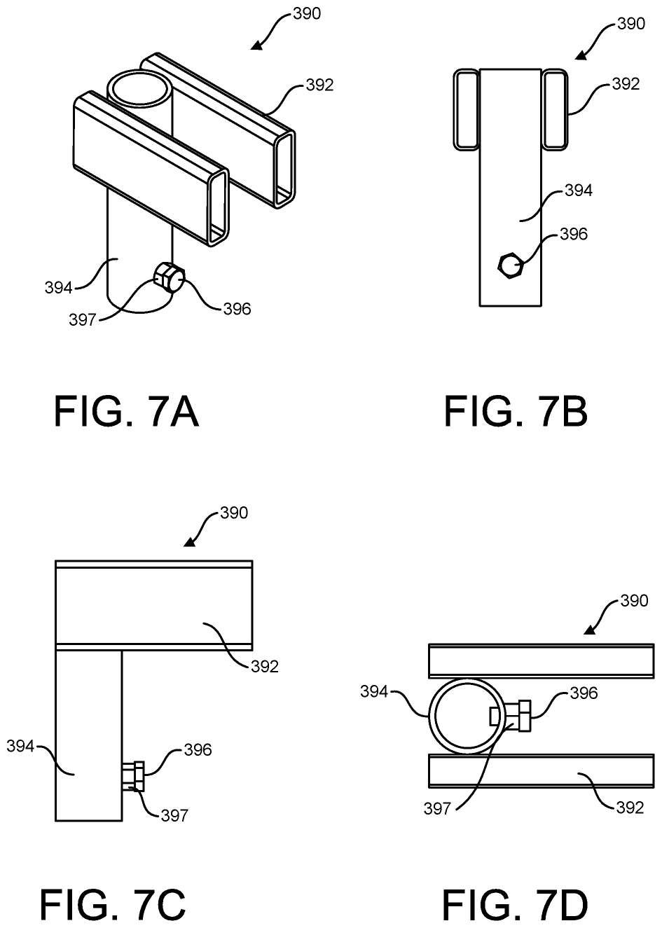

The loading deck 300 can further comprise a hitch attachment 390. As shown in FIG. 7, the hitch attachment 390 can comprise at least one linker arm 392 that connects the hitch attachment 390 to the loading deck 300. The hitch attachment 390 further comprises piping or an alternate structure 394 that serves to connect the portable loading deck 100 to the hitch mechanism of the towing vehicle. The hitch attachment 390 can further include a means for reversibly securing the portable dock trailer 100 to the hitch mechanism of the towing vehicle. In certain embodiments, the means for reversibly securing the dock trailer to the hitch mechanism comprises a bolt 396 alone or in combination with a nut 379. The means for reversibly securing the dock trailer to the hitch mechanism of a towing vehicle can be any means of coupling know or commonly used in the art.

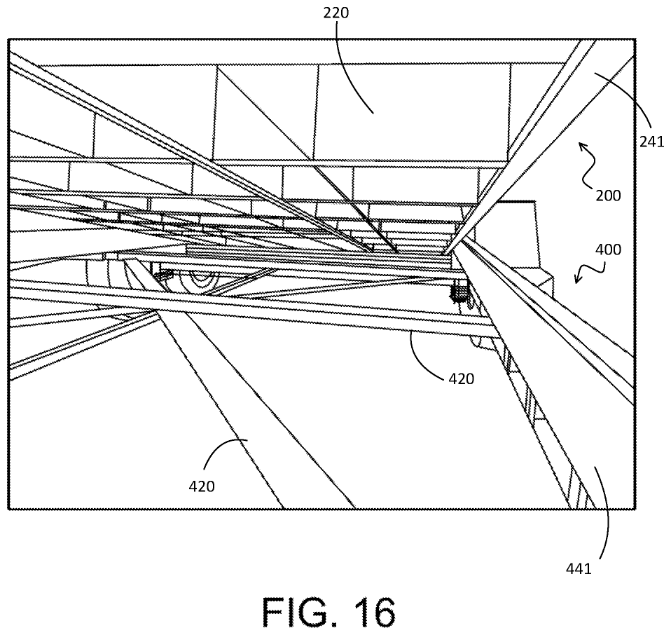

FIGS. 8A, 8B, and 8C provide a top perspective, top, and side view, respectively, of the frame 400 of FIG. 1. The frame 400 can comprise two longitudinal beams 441, 443 that are substantially parallel with one another. In this FIG. 8 embodiment, the frame comprises a front-most structural beam 447. The frame 400 can further comprise at least one transverse structural beam 420. In certain embodiments, the frame 400 comprises up to 10 transverse structural beams 420. As shown in the FIG. 8 embodiment, the frame 400 can comprise up to five transverse beams 420. In embodiments, the frame comprises both longitudinal and transverse beams. The frame can comprise structural beams that traverse from one side to the other at various angles (see 420 at FIG. 16).

The at least two ramp supports 451, 453 can be seen extending upward from the frame 400. The locking pin receiver 455 can be seen at the top of the at least two ramp supports 451, 453. Certain embodiments comprise more than one locking pin receiver 455 disposed at multiple points along each of the at least two ramp supports 451, 453 to permit the user to secure the ramp 200 at multiple vertical positions on the ramp supports 451, 453. Two attachment arm receivers 461, 463 are also shown attached to the frame 400, which, as discussed above, receive and hold the attachment arms 361, 363 of the loading deck 300.

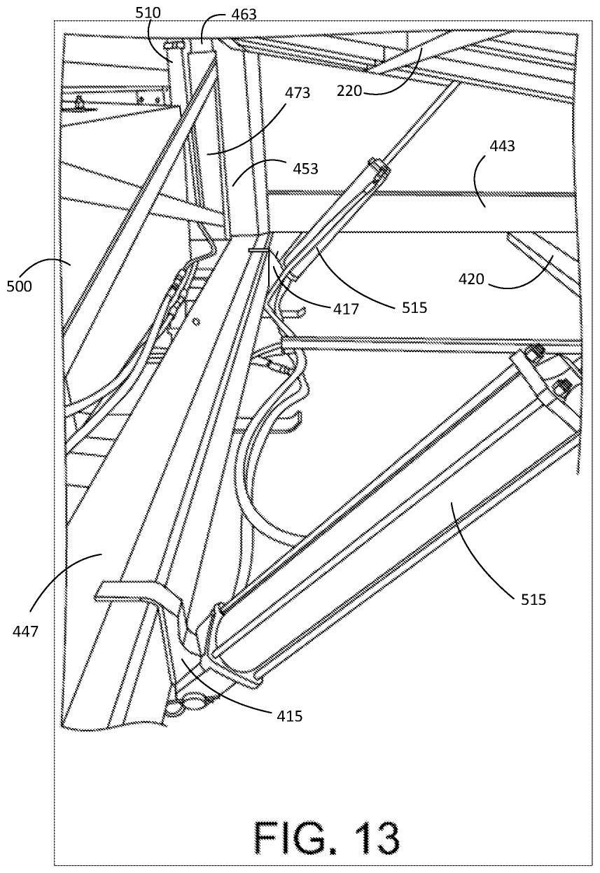

The frame can further include lift mechanism attachment points 410, 412, 414, 417, that permit coupling of the lift mechanisms to the frame. In embodiments, there are two lift mechanism attachment points 410, 412 for coupling the loading deck 300 lift mechanisms to the frame 400 (also seen at 410 of FIG. 12A). Likewise the frame can comprise two lift mechanism attachment points 415, 417 for coupling the ramp 200 lift mechanisms to the frame 400 (also seen at 415, 417 of FIG. 13). In certain embodiments, the frame comprises only a single lift mechanism attachment point for the frame, a single lift mechanism attachment point for the loading deck, or a combination thereof. Embodiments configured to permit manual positioning of the loading deck 300 or frame 400 can be provided without lift mechanism attachment points.

Two foot supports 471, 473 are shown immediately anterior to the attachment arm receivers 461, 463. As stated in more detail above, the foot supports 471, 473 can be lowered to support the portable dock trailer 100 on the ground or raised to permit the dock trailer 100 to be transported. The control box 500 can be seen at the front most portion of the frame 400.

FIG. 10 provides a detailed side schematic view of the junction between the ramp 200 and the loading deck 300 in one embodiment of a portable dock trailer in a loading position. The ramp 200 is shown with two hydraulic cylinders 515 extended to place the ramp in a raised position above the frame 400. The loading deck 300 can be seen in an exemplary loading position. A foot support 473 of the frame is shown extended such that the frame is supported on the ground. A locking pin 456 is shown in the locking pin receiver of the ramp support 453.

FIG. 11 shows a hydraulic cylinder 510 with its piston extended to elevate the loading deck 300, such as when the portable dock trailer assumes a towing position. The bottom surface of the floor 305 of the deck can also be seen. In the pictured embodiment, the ramp 200 can be seen in an inclined position with a locking pin 456 inserted into the lock pin gusset 251. A second hydraulic cylinder (seen at 515 of FIG. 4A) can be seen extending from the frame 400 and supporting the ramp 200 in the inclined position.

FIG. 12A provides a view showing how the hydraulic cylinder of the FIG. 11 embodiment attaches to the frame 400. This view is taken from underneath the loading deck 300, facing the front-most portion of the frame 400. A lift mechanism attachment point 410 (see also 410 at FIG. 8) is shown extending inwardly from an attachment arm receiver 461 of the frame 400.

FIG. 12B provides a view of how the hydraulic cylinder attaches to the underside of the loading deck 300 in one embodiment. The lift mechanism attachment point 310 (also seen at 310 of FIG. 6B) of the loading deck 300 can comprise a U-shaped steel material with each arm of the “U” connected to adjacent structural beams (seen at 320 of FIG. 6) of the loading deck 300.

Although the hydraulic cylinder is attached to the lift mechanism attachment point via a locking pin system in the pictured embodiment of FIG. 12, any attachment means known in the art can be appropriate for the present inventive concept. In alternate embodiments, the lift mechanism can be clamped, welded, bolted, screwed, or otherwise attached to the portable dock trailer.

FIG. 13 shows a side perspective view of two hydraulic cylinders 515 (also seen at 515 of FIG. 4A) extended to support the front of the ramp under one embodiment. A lift mechanism attachment point 415, 417 for each of the hydraulic cylinders can be seen along the interior face of the front-most structural beam 447 of the frame 400. As exemplified by the pictured embodiment, the hydraulic cylinders can be hingedly attached to the frame 400 via the lift mechanism attachment points 415, 417. Such a hinged attachment permits the cylinders to extend from the frame 400 at an angle when raising the ramp 200 to an inclined position, and be stowed as substantially parallel with the frame 400 and the ramp 200 when the ramp assumes a non-inclined position, such as in the towing position of FIGS. 2A, 3B, and 4B.

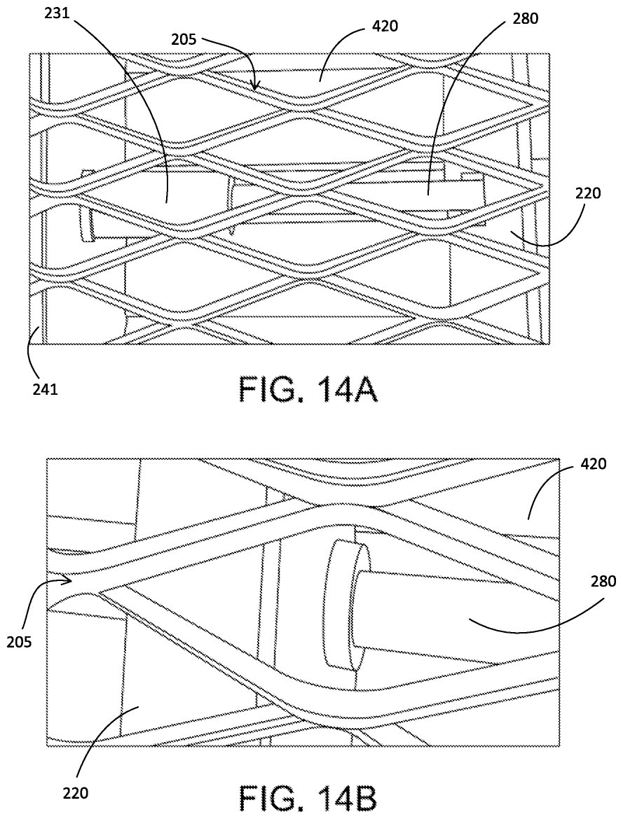

FIG. 14A provides a detail view of the pivot member 280 or linking member exiting a receiver 231 (also shown at 231, 233 of FIG. 5) of the ramp 200. FIG. 14B shows the pivot member 280 extending through one of the support beams 220 (also seen at 220 of FIG. 5) of the ramp 200. In embodiments, the pivot mechanism comprises a single rod 280 that begins from one side of the frame 400 and extends across the width of the portable dock trailer 100 to the opposite side of the frame 400. As shown in FIG. 14A, the ramp 200 can comprise receivers (also represented as 231, 233 in FIG. 5) that are configured to receive the pivot member 280. In embodiments, each of the receivers 231 can be supplied with a grease fitting to ensure proper lubrication of the pivot member 280 within the receiver 231. The frame 400 can also be equipped with a channel or receivers (seen at 431, 433 of FIG. 8) for receiving and holding the pivot member.

In embodiments, the pivot member or linking member comprises a solid metal round crossbar 280. The crossbar 280 can be comprised of any metals, alloys, or combinations thereof. In embodiments, the crossbar 280 is comprised of stainless steel. The receivers 231, 233, 431, 433 can comprise a piping attached to the frame 400, ramp 200, or both.

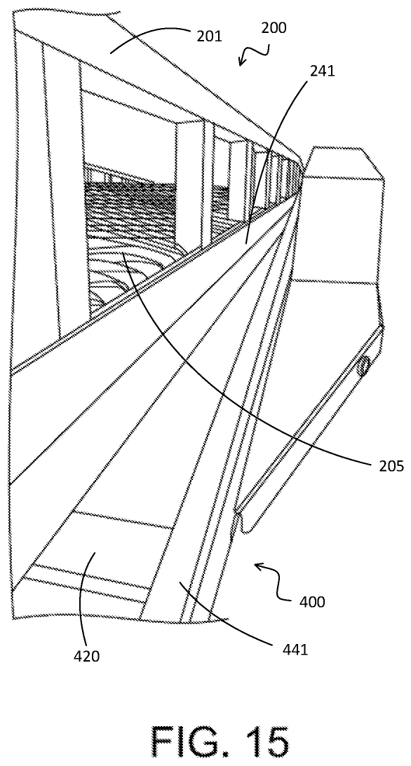

FIG. 15 provides a view looking down one of the longitudinal beams 241 of the ramp with the ramp 200 in a partially raised position. The side rail 201 as well as the floor 205 of the ramp are also partially visible in this view. The frame 400 can be seen below the ramp with a fender attached thereto. A support beam 420 of the frame can be seen extending perpendicular to a longitudinal beam 441 of the frame 400.

FIG. 16 provides a view from underneath the ramp 200 and above the frame 400 with the ramp 200 in an elevated position. The ramp support beams 220 can be seen extending the length and width of the underside of the ramp. Likewise, frame support beams 420 can be seen extending both substantially perpendicular to and at an angle from the longitudinal beam 441 (also seen at 441 and 443 of FIG. 8) of the frame 400.

As shown in the FIGS. 15 and 16 embodiments, the width of the ramp 200 is slightly less than the width of the frame 400. As such, the ramp 200 can be designed to nest within the frame 400 when ramp 200 assumes a non-inclined, stowed position.

FIG. 17A provides a schematic view of an alternate embodiment wherein the loading deck is in a fixed, elevated position as compared to the frame. The view is taken from underneath the loading deck, facing the frame and ramp. The front face of the control box 500 can be seen disposed upon front-most structural beam 447 of the frame 400. The two foot supports 471 are shown in a fully extended position such that the frame is supported by the ground. Each of the attachment arms 363, 361 comprise an attachment arm plate 367, 369 that can be secured to the inward facing surface of the attachment arms, the outward facing surface of the attachment arms, or both. In embodiments, the attachment arm plates 367, 369 can be configured to provide additional support to the attachment arms.

FIG. 17B is a detailed schematic view of the FIG. 17A embodiment. As can be seen, the attachment arm 361 of the loading deck is directly attached to the frame 400 such that the loading deck remains in a fixed, elevated position for towing or loading. Since the loading deck 300 in the embodiments of FIGS. 17A and 17B is fixed in an elevated position, these embodiments lack hydraulic cylinders 510 for raising and lowering the loading deck.

1. A portable dock trailer comprising a frame, a ramp, a loading deck, and a mechanism for raising and lowering the ramp.

2. The portable dock trailer of claim 1, wherein the frame further comprises at least two wheels, and the portable dock trailer is configured to be pulled as a trailer by a towing vehicle.

3. The portable dock trailer of claim 1, wherein the mechanism for raising and lowering the ramp comprise a fluid-powered mechanism.

4. The portable dock trailer of claim 3, wherein the fluid-powered mechanism comprises pneumatics or hydraulics.

5. The portable dock trailer of claim 1, wherein the mechanism for raising and lowering the ramp comprises a manual mechanism configured to be raised and lowered by physically lifting the ramp through the actions of at least one user.

6. The portable dock trailer of claim 1, further comprising a means for reversibly securing the ramp in a locked position.

7. The portable dock trailer of claim 6, wherein the means for reversibly securing the ramp in a locked position comprises a locking pin and a pin receiver, a system of notches and locking bars, or a combination thereof.

8. The portable dock trailer of claim 1, wherein the height of the loading deck is fixed.

9. The portable dock trailer of claim 1, further comprising a mechanism for raising and lowering the loading deck.

10. The portable dock trailer of claim 9, wherein the mechanism for raising and lowering the loading deck comprises a fluid-powered mechanism.

11. The portable dock trailer of claim 10, wherein the fluid-powered mechanism comprises pneumatics or hydraulics.

12. The portable dock trailer of claim 9, wherein the mechanism for raising and lowering the loading deck comprises a manual mechanism configured to be raised and lowered by physically lifting the loading deck through the actions of at least one user.

13. The portable dock trailer of claim 9, further comprising a means for reversibly securing the loading deck in a locked position.

14. The portable dock trailer of claim 6, wherein the means for reversibly securing the loading deck in a locked position comprises a locking pin and a pin receiver, a system of notches and locking bars, or a combination thereof.

15. The portable dock trailer of claim 1, wherein the ramp is secured to the frame via at least one pivot member, wherein the pivot member is configured to permit the ramp to be raised and lowered with relation to the frame.

16. The portable dock trailer of claim 1, further comprising a ramp bridge member, wherein the ramp bridge member is disposed at a back end of the ramp and configured to prevent a gap from forming between the ramp and ground surface when the ramp assumes a loading position.

17. The portable dock trailer of claim 1, further comprising:
a first loading deck bridge member and a second loading deck bridge member, wherein
the first loading deck bridge member is disposed at a back end of the loading deck and configured to prevent a gap from forming between the loading deck and the ramp when the ramp assumes a loading position; and
the second loading deck bridge member is disposed at a front end of the loading deck and configured to prevent a gap from forming between the loading deck and a loading surface.

18. The portable dock trailer of claim 2, wherein the loading deck is configured to attach to a towing vehicle via a class 1-5 receiver hitch, a bumper-mounted hitch, a 5th wheel hitch, a gooseneck hitch, any other suitable hitch mechanism, or combinations thereof.

19. The portable dock trailer of claim 1, wherein the dock trailer further comprises at least one foot support, wherein the at least one foot support is retractable and configured to support the portable dock trailer when the dock trailer assumes a loading position.

20. The portable dock trailer of claim 19, comprising at least two foot supports, wherein each foot support is configured to be raised and lowered independently.

21. A method of loading and unloading cargo when no loading dock is available, the method comprising:
hauling a portable dock trailer to a loading site;
placing the portable dock trailer in a loading position; and
loading or unloading cargo into a receiving unit.

22. The method of claim 21, further comprising the portable dock trailer of any one of claims 1-20.

23. A system for unloading and loading cargo, the system comprising a portable dock trailer, wherein the portable dock trailer is configured to assume a towing position, a loading position, or a combination thereof.

24. The system of claim 23, wherein the portable dock trailer further comprises a frame, a ramp, a loading deck, a mechanism for raising and lowering the ramp, or a combination thereof, wherein
a front end of the ramp is lowered relative to the loading deck when in the towing position; and
the front end of the ramp is adjacent to the loading deck when in a loading position.
